(19) United States
(12) Patent Application Publication
(10) Pub. No.: US 2012/0144736 A1
(43) Pub. Date: Jun. 14, 2012

(54) Plant Winter Blanket

(76) Inventor: Emile Anthony Williams, Valrico, FL (US)

(21) Appl. No.: 12/964,258

(22) Filed: Dec. 11, 2010

(51) Int. Cl. A01G 13/02

(52) U.S. Cl. 47/20.1

(57) ABSTRACT

This invention takes into consideration the severe weather that plants have to endure during the winter months. Home owners and owners of large complexes such as subdivision landscapes, and botanical parks tend to encounter huge expenses to replace plants that have been destroyed during the severe winter months.

The plant winter blanket based on its construction allows plant material to withstand severe winter temperatures well below freezing without the freezer burn or damage that is normally associated with plant winter damage. The plant winter blanket consists of various levels of insulation quilted together. The outer layer is both moisture resistant and sun light reflective, the middle layers consist of insulative material, and the inner layers remove excess moisture from foliage that may result in freezer burn.

The capabilities mentioned above renders the plant winter blanket a vital step in preserving the environment, as well as saving thousands of dollars in plant replacement.

### BACKGROUND OF THE INVENTION

In the past severe winters have taken a toll on plants and vegetation destroying them to the extent that they have to be replaced.

To combat the effects of this recurring event throughout most temperate climates, home owners, landscapers, parks and recreation, and large modern day housing sub-divisions have resorted to replacing damaged plants every spring in order to maintain the aesthetic nature of their surroundings.

The replacement of these much plants can cost thousands of dollars with a cumulative effect ranging in the hundreds of thousands even millions across the United States alone.

Any attempt to stem the tide of this much revenue being spent on plant and landscape replacement should be regarded as a step in the right direction for all involved.

A number of varying inventions deal with the protection of soil from erosion, protection of landscaping from weed growth by creating weed barriers, and varying types of shade that may protect from sunlight and UV damage. Some of these inventions are as follows:
U.S. Pat. No. 4,651,465 issued Mar. 24, 1987, to Lilly et al;
U.S. Pat. No. 4,901,472 issued Feb. 20, 1990, to Donohue et al;
U.S. Pat. No. 4,818,585 issued Apr. 4, 1989, to Shipp et al;
U.S. Pat. No. 5,934,013 issued August, 1999 to Barra;
U.S. Pat. No. 5,783,504 issued Jul. 21, 1988 to Ehret et al;
U.S. Pat. No. 5,532,298 issued Jul. 2, 1996, to Monroe et al;
U.S. Pat. No. 7,637,053 issued Dec. 29, 2009, to McAnulty;
U.S. Pat. No. 7,117,633 issued Oct. 10, 2006 to Schmidt;

In the above prior art specifically U.S. Pat. Nos. 7,117,633 and 4,901,472 makes an attempt to achieve warmth for plants during winter by utilizing fabric wrap incorporated with heating elements for temperature control.

The inherent element of my invention uses a combination of various fabrics each with their own individual ability to control the environment, through moisture reduction, UV reflection and heat absorption, cold temperature resistance, and the ability of the inner fabric to draw moisture away from the foliage.

The fabric will be constructed in triangular sections enabling various configurations to be constructed based on your individual needs.

By joining two sections together an individual can create rectangular pieces or sections can be used to create top pieces for irregularly shaped plants.

### SUMMARY OF THE INVENTION

The winter months in the majority of the USA including southern states such as Florida and Texas, reek havoc on vegetation with special emphasis on esthetic landscaping plants.

As a result millions of dollars are spent each year in Spring replacing plants and shrubs that have been destroyed due to severe cold weather.

The winter plant blanket is intended to preserve and protect these plants from destruction, by maintaining a dry warm envelope around the leaves and core of the plant.

The inner layer of the plant winter blanket that rests against the leaves of the plant is made of a flannel based fabric that provides warmth as well as absorption of residual moisture away from the leaves.

The two middle layers provide an ‘R’ rating that blocks cold penetration.

The outer layer is both light reflective as well as water and moisture proof enabling the reflection of harmful UV rays but with the benefit of absorbing warmth, while preventing water from entering the fabric.

Velcro sealed edges ensure minimal cold air entering through the joined edges.

The winter plant blanket would be manufactured in varying sizes and shapes to accommodate large and small plants.

One of the shapes will be triangular, allowing the attachment of multiple triangular sections that will accommodate unusual shapes.

Each edge will consist of Velcro material on the interior and exterior edges such that, texture opposed Velcro fabric on the interior, will have the opposing textured Velcro fabric on the exterior or vice versa.

Another manufactured shape would be rectangular, with the same principal being applied to its edges as far as the application of Velcro material is concerned.

The layers of this blanket will be mounted to each other in a crisscrossed fusion method similar to a quilting pattern. This ensures the stability of the layers as well as adds to the overall strength of the layered blanket.

The aesthetic value of this blanket is also evident in comparison to the choices of various domestic blankets and fabrics currently used by homeowners and landscapers alike.

### Method of Use

The Plant Winter Blanket can be utilized by first determining the size of the tree or shrub that needs to be covered in terms namely its width and height.

Since the Plant Winter Blanket will be made in varying shapes and sizes, a determination has to be made as to which size and shape most appropriately suit the specific application.

After determining the above mentioned parameters the user will then join the sections of the Plant Winter Blanket to achieve the size needed by attaching the Velcro edges to each other, ensuring the joins are tightly secured with no evident air gaps.

The constructed fabric is wrapped with the outer reflective area as the exterior area such that the fabric reaches down to the ground surrounding the plant, forming an enclosed area around the bottom of the plant as well as the entire plant.

The wrap around the plant should be such that the leading edge overlaps the trailing edge or beginning edge of the Plant Winter Blanket.

The leading Velcro edge should now be wrapped an additional half circumference around the plant, and attached securely to the exposed alternative Velcro edges on the exterior surface of the fabric.

The user can, based on their discretion, apply more than one layer of these blankets, or place more continuous wraps depending on the discerned severity of the cold spell.

Landscape pins are placed at the base of the blankets fastening the bottom edges of the winter plant blanket to the ground ensuring that cold air does not enter from the bottom of the plant, thereby protecting the root area from exposure to the cold.

Some plants based on their shape and height can be covered by placing the constructed blankets over the tops ensuring that enough blanket material is attached to allow the fabric to reach to the ground on all sides of the plant. As well as its top.

The bottom of this type of covering pattern must be long enough to be gathered into a noose at the base trunk of the plant with enough fabric reaching to the ground on all sides of the trunk.

This will enable the pinning of the fabric to the ground around the circumference of the trunk protecting it.

### BACKGROUND ART

The background of this invention, is an attempt to bridge the gap of efforts being made by varying individuals to protect their plants in the winter, utilizing varying fabrics and methods to keep plants warm.

It brings together multiple materials that have been used in the past for varying uses including insulation, but not in a combination that utilizes a method of layering to achieve a warm enclosure for a plant or vegetation.

The use of layering has been used in the past for quilt blankets, and varying blankets to provide warmth for human beings and pets alike.

The Plant Winter Blanket utilizes layering materials with the similar properties of the above mentioned quilt blanket, but with the robustness to withstand external weather conditions of moisture, wind, heat and cold.

The added attention to keeping the trunk base also protected by pinning the fabric in an air tight manner to the ground with landscape pins, also ensures total protection from the elements.

### General Description and Preferred Modes of Invention

The present invention provides a novel approach to Plant protection during severe winter weather as a preferred embodiment of which may be utilized for protecting plants and vegetation during harsh winter weather.

The present invention provides a warm enclosure achieved by wrapping a constructed multiple layered fabric around a plant, tree or vegetation to provide a means of protecting the plant and thereby the environment from severe winter damage.

This invention therefore also saves considerable cost in the replacement of plants by homeowners, landscapers, large corporations, city parks, and horticulturists in general.

The foregoing disclosure and description of the invention is therefore illustrative and explanatory of a presently preferred embodiment of the invention and variations thereof, and it will be appreciated by any individual or landscaper who has struggled with the ability to protect and save the plants during winter months. As well, the drawings are intended to describe the concepts of the invention so that the presently preferred embodiments of the invention will be plainly disclosed to all individuals familiar with the attempts of protecting plants from destruction during severe winter cold, but are not intended to be manufacturing level drawings or renditions of final products and may include simplified conceptual views.

Thus, various changes and alternatives may be utilized that remain within the spirit of the invention. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative of a presently preferred embodiment and not in a limiting sense.

### BRIEF DESCRIPTION OF DRAWINGS

These and other features will become more apparent from the following description in which reference is made to the appended drawings, the drawings are for the purpose of illustration only and are not intended to be in any way limiting, wherein:

FIG. 1 is a side view of the Plant Winter Blanket with the four (4) layers detached for illustration purposes.

FIG. 2 is a side view of the Plant Winter Blanket with the four (4) layers fused for illustration purposes.

FIG. 3 is an illustrative drawing demonstrating the upper and lower surfaces of the blanket, as well as the opposed Velcro edges of the upper and lower surfaces.

FIG. 4 is yet another elevation of the upper and lower surfaces of the Plant Winter Blanket and the orientation by which the lower and upper surface edges attach to each other.

FIG. 5 shows how the complete Plant Winter Blanket can be utilized to cover a plant for insulative protection, by encompassing the plant and pinning the lower end of the blanket to the ground with landscape pins.

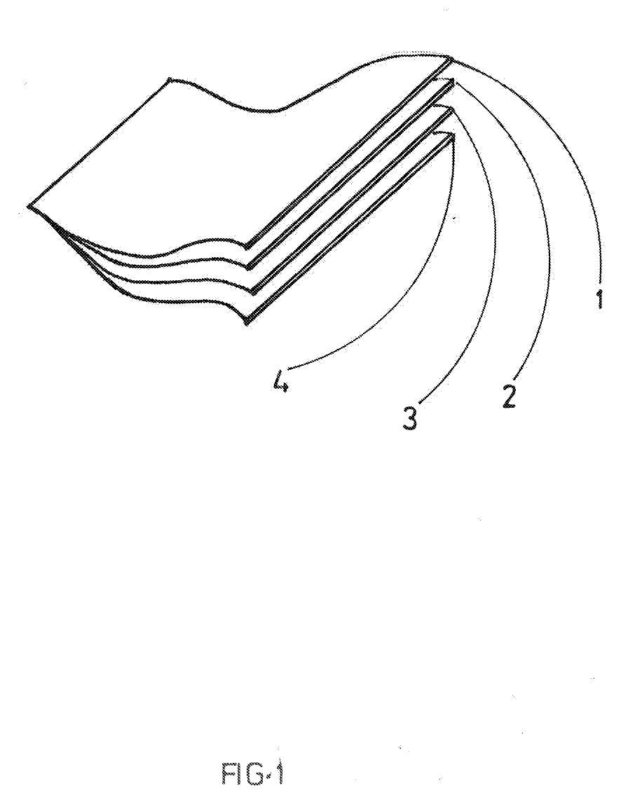

FIG. 1 shows the four layers of the Plant Winter Blanket, the outer layer 1 comprises of a reflective waterproof material such as an insulative heat sheet. The two middle layers 2 and 3 comprise of a thin anti static foam sheet approximately one millimeter to two millimeters thick. The inner and final layer 4 comprises of a cotton batting fabric that allows the absorption of moisture away from the plant surface.

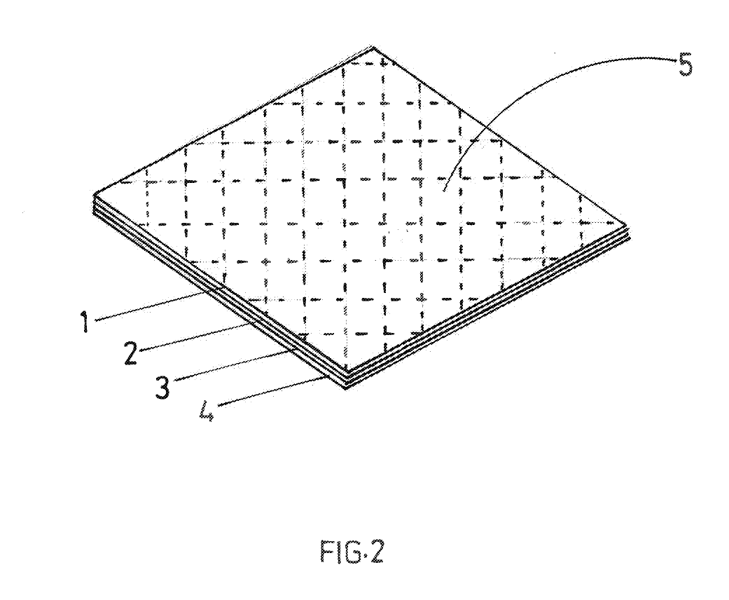

FIG. 2 illustrates the four layers fused together with the outer reflective layer having the cross-hatched pattern of the quilted stitching or fusing 5, which promotes stability and strength of the four fused layers.

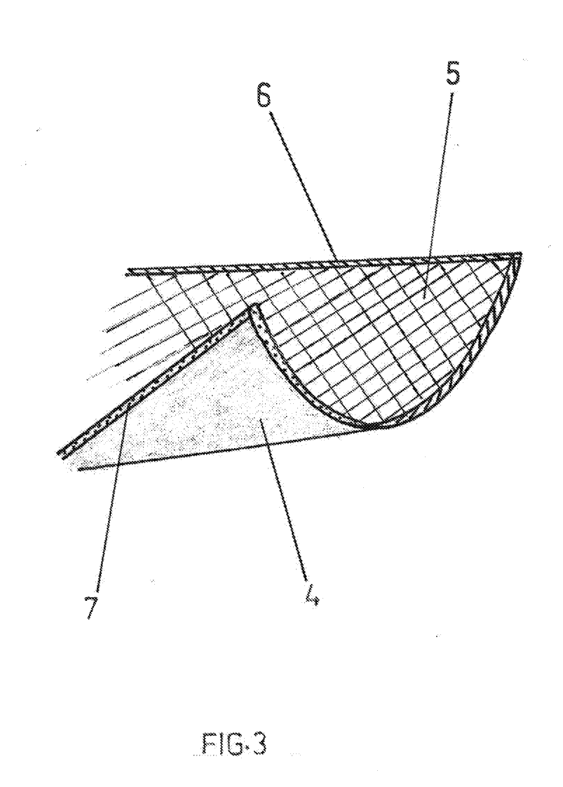

FIG. 3 shows the orientation of the alternate Velcro edges 6 of the outer heat sheet surface and 7 of the inner cotton batting surface.

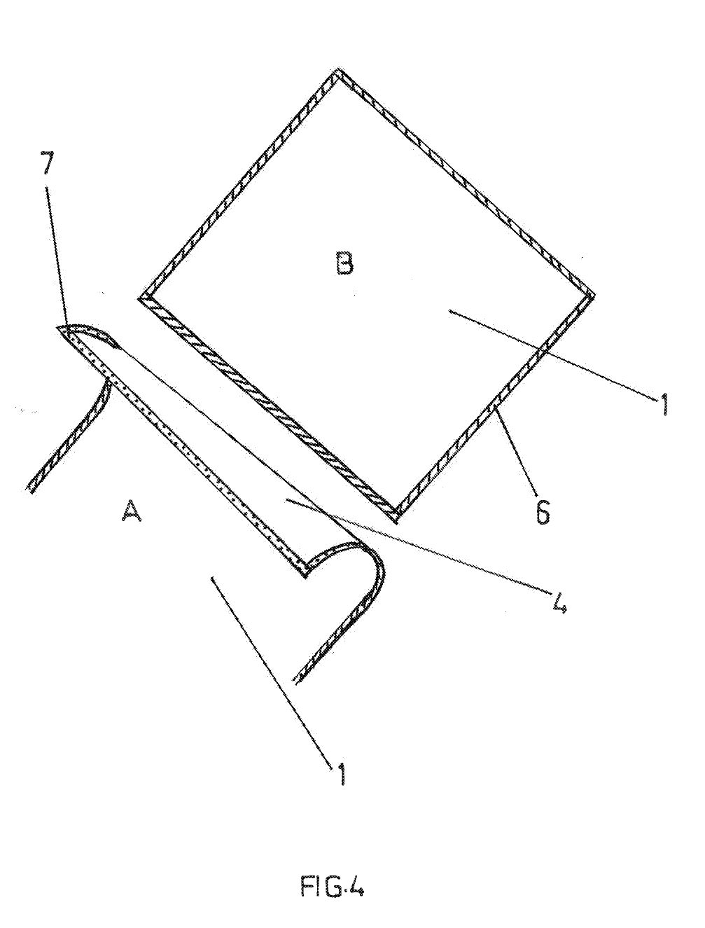

FIG. 4 demonstrates the method in which two edges will be fastened such that the Velcro of the inner surface 4 of sheet A will be attached to the outer surface 1 of sheet B to form a sealed or continuous sheet.

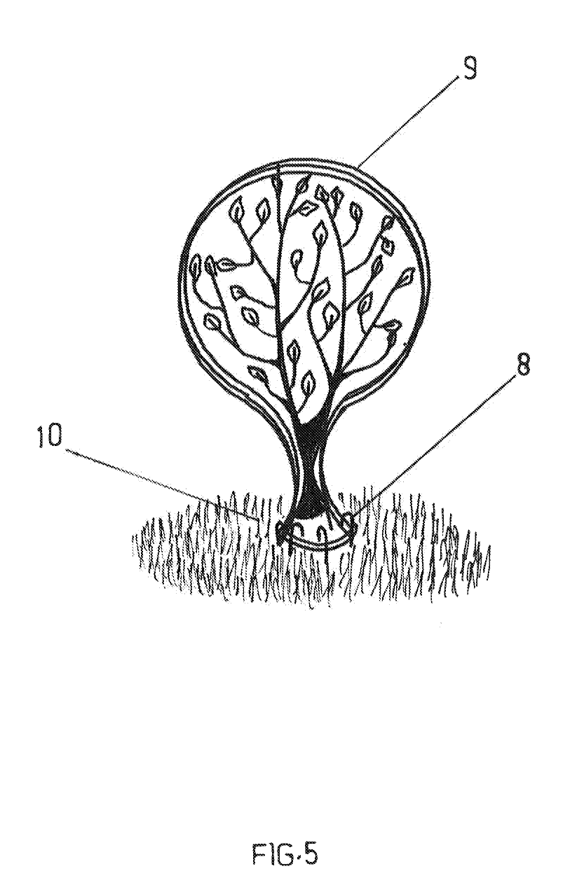

FIG. 5 illustrates a cross sectional view of one method of wrapping or encapsulating 9 a plant and the application of landscape pins 8 around the surrounding base of the plant against the ground 10 to achieve an effective barrier against the severe cold.

I hereby claim that the design is:

1. An external plant winter blanket that is constructed of materials that withstand the various conditions of winter weather so as to maintain a controlled temperature around any plant that it is wrapped around.

2. The said external plant winter blanket of claim 1 comprises of four (4) layers of material each with a specific purpose rendered towards promoting a controlled temperature around any external plant that it wraps.

3. The said four layers of claim 2 are constructed together using quilting, which holds all layers in place, ensuring greater reliability.

4. The first of the said four layers of claim 2 is the outer layer. This layer is made of a thin waterproof fabric with a reflective silver grey surface on its outer surface, that reflects the morning sun thereby preventing UV light damage during those hours of the day when the sun may be hot enough to damage the plant being covered.

5. The said reflective outer layer of claim 4 controls the rise of temperature throughout the inner layers and therefore the temperature that reaches the plant surface, thereby protecting the plant from being scorched by the day time sun.

6. The second and third layers of the four layers of claim 2 are made of Styrofoam sheeting one millimeter to two millimeters thick each. These two layers are the main layers that protect the plant surface from extreme freezing temperatures.

7. The said Styrofoam layers of claim 6 provide an ‘R’ rating that protects the plant from becoming frozen.

8. The fourth and final layer of the said four layers of claim 2 is the moisture barrier that ensures condensation is removed from the surface of the plant ensuring that the moisture does not freeze on the surface of the plant during freezing temperatures.

9. The said layer four of claim 8 comprises of a fabric such as cotton batting that also promotes insulation due to the nature of the fabric. Its composition removes moisture away from the surface and allows the moisture to evaporate.

10. The said external plant winter blanket of claim 1 is constructed with alternating Velcro edges on all edges of the blanket.

11. The said Velcro edges of claim 10 occur on both the inner and outer edge of all four sides of the said winter blanket. This enables the joining of various blankets to form larger blanket sections.

12. The said Velcro edges of claim 10 also enables the said external plant winter blankets of claim 1 to be wrapped and sealed one edge to the other to form an air tight closed cocoon, further helping to keep moisture and cold from reaching the plant surface.
